(19) United States
(12) Patent Application Publication
(10) Pub. No.: US 2012/0112646 A1
(43) Pub. Date: May 10, 2012

(54) CONVERTING CONTROL CIRCUIT

(75) Inventors: Shian-Sung SHIU, New Taipei City (TW); Hai-Po LI, Wuxi (CN); Chih-Chun SUNG, Wuxi (CN); Juan-Juan LIU, Wuxi (CN)

(73) Assignee: GREEN SOLUTION TECHNOLOGY CO., LTD., New Taipei City (TW)

(21) Appl. No.: 13/253,954

(22) Filed: Oct. 5, 2011

(30) Foreign Application Priority Data
Nov. 8, 2010 (CN) 201010539647.3

(51) Int. Cl. H05B 37/02

(52) U.S. Cl. 315/186

(57) ABSTRACT

A converting control circuit, adapted to control a converting circuit to convert an input voltage into an output voltage for driving a load, is provided. The converting control circuit comprises a current control circuit, a first detecting circuit, a second detecting circuit, a feedback controller and a feedback circuit. The current control circuit comprises at least one control end coupled to the load to adjust a current flowing through the load. The first detecting circuit is coupled to the current control circuit and generates a first detecting signal according to the voltage at the least one control end. The second detecting signal is coupled to the converting circuit and generates a second detecting signal according to the output voltage. The feedback circuit is coupled to the first and second detecting circuit and modulates a level of the second signal according to the first detecting signal.

### RELATED APPLICATIONS

This application claims priority to China Application Serial Number 201010539647.3, filed Nov. 8, 2010, which is herein incorporated by reference.

### BACKGROUND OF THE INVENTION

(1) Field of the Invention

This invention relates to a converting control circuit, and more particularly relates to a converting control circuit which is capable of modulating output power to a load according to the condition of the load.

(2) Description of the Prior Art

With the rapid progress of LED (Light Emitting Diode) lighting technology as well as the maturity of relative technologies and the conscious of energy saving and carbon reduction, the LED has been applied in various fields of industry and is popular in daily life, and the usage of LEDs has been extended from low power applications such as a power indicator lamp and a lighting source for a keypad on a mobile phone to a backlight module for a flat panel display and other daily lighting devices.

Because the LED belongs to a nonlinear load, which features a threshold voltage changed with the increase of temperature and a spectrum profile changed with the variation of driving current, it is much more difficult to drive the LED module to generate a steady illumination in comparison with other lighting sources. In addition, because the illumination provided by one single LED cannot fulfill most of the demands nowadays, multiple LEDs should be connected in parallel, in series or in series and parallel as a single light source for providing enough illumination. However, the driving variations of the LEDs are quite large. An identical driving voltage applied to the LEDs may not lead to an identical driving current and the identical brightness. Thus, a current balancing circuit is required for equating the current on each of the LED strings connected in parallel for uniform brightness. On the other hand, the driving voltage applied to the each of the LED strings should be calculated according to the greatest threshold voltage of the LEDs to make sure that all the LEDs are lightened. In addition, as the threshold voltage of each LED cannot be correctly predicted, the driving voltage needs to be higher to make sure that all the LEDs are supplied with a predetermined driving current. However, such cases may result in a low driving efficiency. Moreover, when the LEDs are connected in series, the LEDs may be in an open circuit due to the broke of any one LED thereof, which may result in the increase of the driving voltage, and thus the driving current cannot reach the predetermined driving current or the LEDs are even shut down as the LEDs is driven under constant voltage mode.

The above mentioned problems should be addressed in the design of LED driving circuit, and it has become a challenge of circuit design to figure out a driving circuit to drive an array of LEDs connected in a combination of both in series and in parallel.

### SUMMARY OF THE INVENTION

Because of the difficulties resulted from the driving properties of LEDs, conventional driving circuits are not suitable for use in driving the LEDs or fail to drive the LEDs precisely. Accordingly, a feedback circuit architecture is provided in the present invention for generating the feedback signal according to the actual condition of the LEDs, such that even a conventional feedback controller utilized for controlling a converting circuit may drive the LEDs precisely by using the feedback circuit architecture disclosed in the present invention. In addition, the feedback circuit architecture disclosed in the present invention is also capable of compensating the feedback control operation of a typical converting circuit, such that the typical converting circuit is capable of driving the LEDs precisely.

For achieving the aforementioned object, a converting control circuit, adapted for controlling a converting circuit to convert an input voltage into an output voltage to drive a load, is provided. The converting control circuit includes a current control circuit, a first detecting circuit, a second detecting circuit, a feedback controller, and a feedback circuit. The current control circuit has at least one control end coupled to the load for modulating a current of the load. The first detecting circuit is coupled to the current control circuit and generates a first detecting signal according to a voltage of the control end. The second detecting circuit is coupled to the converting circuit and generates a second detecting signal according to the output voltage. The feedback controller controls the converting circuit to convert the input voltage into the output voltage in response to the second detecting signal. The feedback circuit is coupled to the first detecting circuit and the second detecting circuit and generates a feedback signal to modulate a level of the second detecting signal according to the first detecting signal.

Another converting control circuit, adapted for controlling a converting circuit to convert an input voltage into an output voltage to drive a load, is also provided. The converting control circuit includes a controller, a detecting circuit, and a feedback circuit. The controller is utilized to control the converting circuit to convert the input voltage into the voltage. The detecting circuit is coupled to the load for generating a detecting signal. The feedback circuit is coupled to the detecting circuit and generates a feedback signal according to the detecting signal. The feedback circuit has a capacitor and a charging/discharging unit. The capacitor is utilized for generating the feedback signal. The charging/discharging unit is utilized for charging or discharging the capacitor.

Still another converting control circuit, adapted for converting an input voltage into an output current to drive a load, is also provided. The converting control circuit includes a regulator, a detecting circuit, and a feedback circuit. The detecting circuit is coupled to the load for generating a detecting signal. The feedback circuit is coupled to the detecting circuit and generates a feedback signal according to the detecting signal. The feedback circuit has a capacitor and a charging/discharging unit. The capacitor is utilized for generating the feedback signal. The charging/discharging unit is utilized for charging or discharging the capacitor. The regulator is coupled between the input voltage and the load, and supplies the output current at a predetermined current value in response to the feedback signal.

### BRIEF DESCRIPTION OF THE DRAWINGS

The present invention will now be specified with reference to its preferred embodiment illustrated in the drawings, in which:

FIG. 1 is a block diagram of a converting control circuit in accordance with the present invention;

FIG. 2 is a block diagram of another converting control circuit in accordance with the present invention;

FIG. 3 is a schematic circuit diagram of a feedback circuit in accordance with a first preferred embodiment of the present invention;

FIG. 4 is a schematic circuit diagram of a feedback circuit in accordance with a second preferred embodiment of the present invention;

FIG. 5 is a schematic circuit diagram of a feedback circuit in accordance with a third preferred embodiment of the present invention;

FIG. 6 is a schematic circuit diagram of a converting control circuit in accordance with a first preferred embodiment of the present invention which uses a prior regulator to drive the load;

FIG. 7 is a schematic circuit diagram of a converting control circuit in accordance with a second preferred embodiment of the present invention; and

FIG. 8 is a schematic circuit diagram of a converting control circuit in accordance with a third preferred embodiment of the present invention.

### DESCRIPTION OF THE PREFERRED EMBODIMENT

FIG. 1 is a block diagram of a converting control circuit in accordance with the present invention. As shown in FIG. 1, the converting control circuit (not labeled) includes a controller 130, a detecting circuit 105, and a feedback circuit 100. The converting control circuit is utilized for controlling a converting circuit 140 to convert an input voltage Vin into an adequate power, such as a current source, for driving a load 160. The detecting circuit 105 is coupled to the load 160 for generating a detecting signal Sde1. The feedback circuit 100 is coupled to the detecting circuit 105 for generating a feedback signal Sco according to the detecting signal Sde1. The controller 130 modulates the converting operation of the converting circuit 140 according to the feedback signal Sco. Since the detecting circuit 105 generates the detecting signal Sde1 according to the actual condition of the load 160 being driven, the converting circuit 140 is capable of driving the load 160 properly.

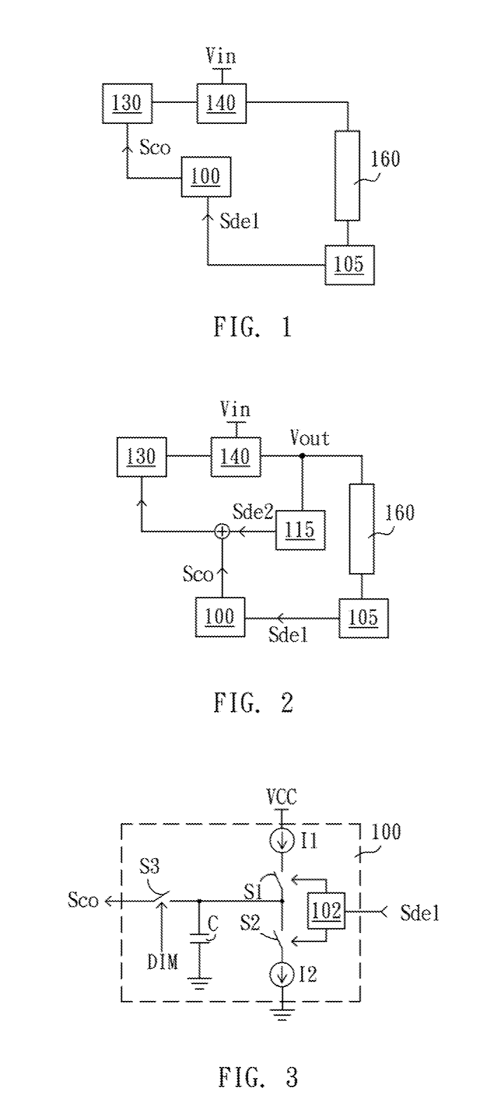

FIG. 2 is a block diagram of another converting control circuit in accordance with the present invention. As shown in FIG. 2, the converting control circuit, including a first detecting circuit 105, a second detecting circuit 115, a feedback controller 130, and a feedback circuit 100, is utilized for controlling a converting circuit 140 to convert an input voltage Vin into an output voltage Vout to drive a load 160. The first detecting circuit 105 is coupled to the load 160 for generating a detecting signal Sde1 which is an indicative of the actual condition of the load 160. The second detecting circuit is coupled to the converting circuit 140 for generating another detecting signal Sde2 according to the output voltage Vout. The feedback circuit 100 is coupled to the first detecting circuit 105 and the second detecting circuit 115 and generates a feedback signal Sco according to the detecting signal Sde1, and the feedback signal Sco is utilized for modulating a level of the detecting signal Sde2. The feedback controller 130 controls the converting operation of the converting circuit 140 according to the modulated detecting signal Sde2. In comparison with the converting control circuit of FIG. 1, the feedback signal Sco generated by the feedback circuit 100 in FIG. 2 is utilized for compensating the detecting signal Sde2 generated by the second detecting circuit 115. Although the actual condition of the load 160 cannot be determined by the output voltage Vout of the converting circuit 140 which is detected by the second detecting circuit 115, the converting operation of the converting circuit 140 can be properly modulated by the detecting signal Sde1 generated by the first detecting circuit 105.

FIG. 3 is a schematic circuit diagram of a feedback circuit 100 in accordance with a first preferred embodiment of the present invention. As shown in FIG. 3, the feedback circuit 100 includes a capacitor C and a charging/discharging unit (not labeled). The charging/discharging unit includes a first current source I1, a second current source I2, a first switch S1, a second switch S2, and a charging/discharging control circuit 102. The charging/discharging control circuit 102 receives the detecting signal Sde1, and accordingly controls the on/off states of the first switch S1 and the second switch S2 to generate the feedback signal Sco. For example, the charging/discharging control circuit 102 may compare a level of the detecting signal Sde1 with a predetermined level, and have the capacitor C discharged by the second current source I2 when the level of the detecting signal Sde1 is higher than the predetermined level, and have the capacitor charged by the first current source I1 when the level of the detecting signal Sde1 is lower than the predetermined level. In addition, the feedback circuit 100 may include an additional output control switch S3 coupled to the capacitor C to control whether the feedback signal Sco is outputted or not. As a preferred embodiment, the state of the output control switch S3 may be controlled by a dimming signal DIM so as to coordinate the feedback operation with the dimming control for the load.

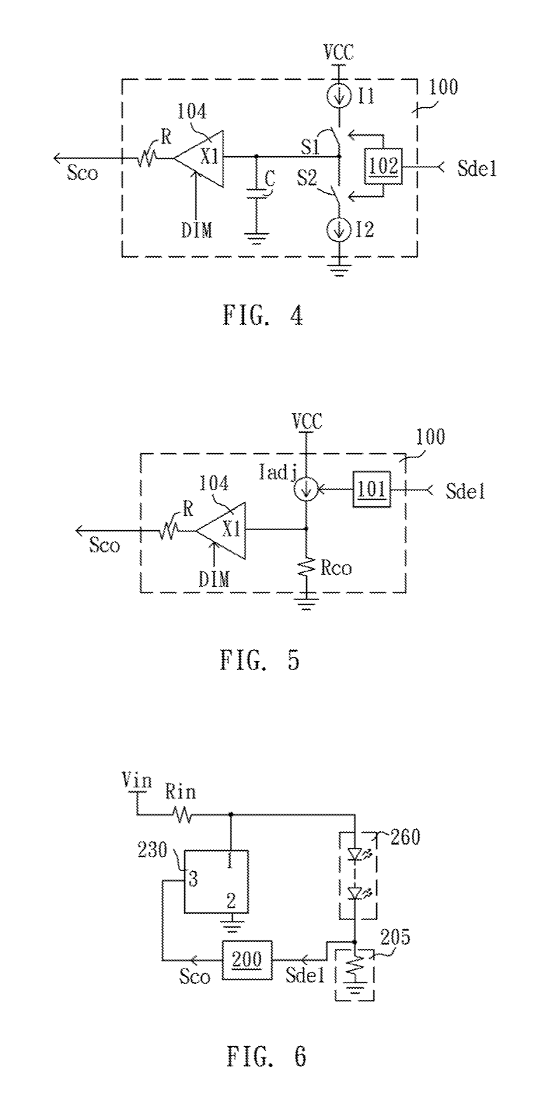

FIG. 4 is a schematic circuit diagram of the feedback circuit in accordance with a second preferred embodiment of the present invention. In comparison with the embodiment in FIG. 3, the feedback circuit shown in FIG. 4 has an additional de-coupling unit 104 and an output resistance R. The de-coupling unit 104 is utilized to prevent the charges stored in the capacitor C of the feedback circuit 100 from being influenced by the outside circuit transmitting energy thereto. In the present embodiment, the de-coupling unit 104 is an X1 amplifier, which may enhance the driving capability of the feedback circuit 100 in addition to the de-coupling ability. In addition, the dimming signal DIM may be used to activate or deactivate the de-coupling unit 104 so as to coordinate the feedback operation with the dimming control for the load.

FIG. 5 is a schematic circuit diagram of a feedback circuit in accordance with a third preferred embodiment of the present invention. In comparison with the embodiment of FIG. 4, the capacitor C and the charging/discharging unit in FIG. 4 are replaced by a current modulating circuit 101, a controlled current source ladj, and an impedance unit Rco. The current modulating circuit 101 controls the current flowing from the controlled current source ladj through the impedance unit Rco according to the first detecting signal Sde1. The de-coupling unit 104 generates the feedback signal Sco through the output resistance R according to the signal from the impedance unit Rco. The feedback circuit in the present embodiment featuring the capacitor C has better anti-noise capability as well as faster transient response.

In addition, the feedback circuit 100 is electrically connected to a driving voltage VCC and a ground such that the level of the feedback signal Sco is constrained in a range between the level of the driving voltage VCC and the ground. Therefore, the modulating range of the detecting signal Sde2 is controlled according to the compensation range determined by the feedback signal Sco. Moreover, the modulating range also can be controlled by adjusting the resistance of the output resistance R.

FIG. 6 is a schematic circuit diagram of a converting control circuit in accordance with a first preferred embodiment of the present invention which uses a conventional regulator to drive the load. A regulator 230 converts an input voltage Vin into an output current at a predetermined current value according to a feedback signal Sco generated by a feedback circuit 200 for driving a load 260. The regulator 230 is composed of a feedback controller and a converting circuit. The load is a single-string LED module. For example, the regulator TL431 of Texas Instruments may be used as the regulator 230 in the present embodiment. The other linear dropout regulators (LDO) are also applicable to the present embodiment for executing power conversion.

A detecting circuit 205 is coupled to the load 260 and generates a detecting signal Sde1 according to a current flowing through the load 260. The feedback circuit 200 is coupled to the detecting circuit 205 and generates the feedback signal Sco according to the detecting signal Sde1. In the present embodiment, the feedback circuit may be any feedback circuit shown in the embodiments or the equivalence disclosed in the present invention. The input end 1 of the regulator 230 is coupled to an input voltage end through an input voltage Rin. The grounding end 2 of the regulator 230 is grounded. The signal end 3 of the regulator 230 receives the feedback signal Sco. Therefore, the regulator 230 adjusts the value of a shunt current input from the input end1 according to the feedback signal Sco so as to have the current flowing through the LED module in the load 260 stabilized at the predetermined current value, thus generating steady illumination.

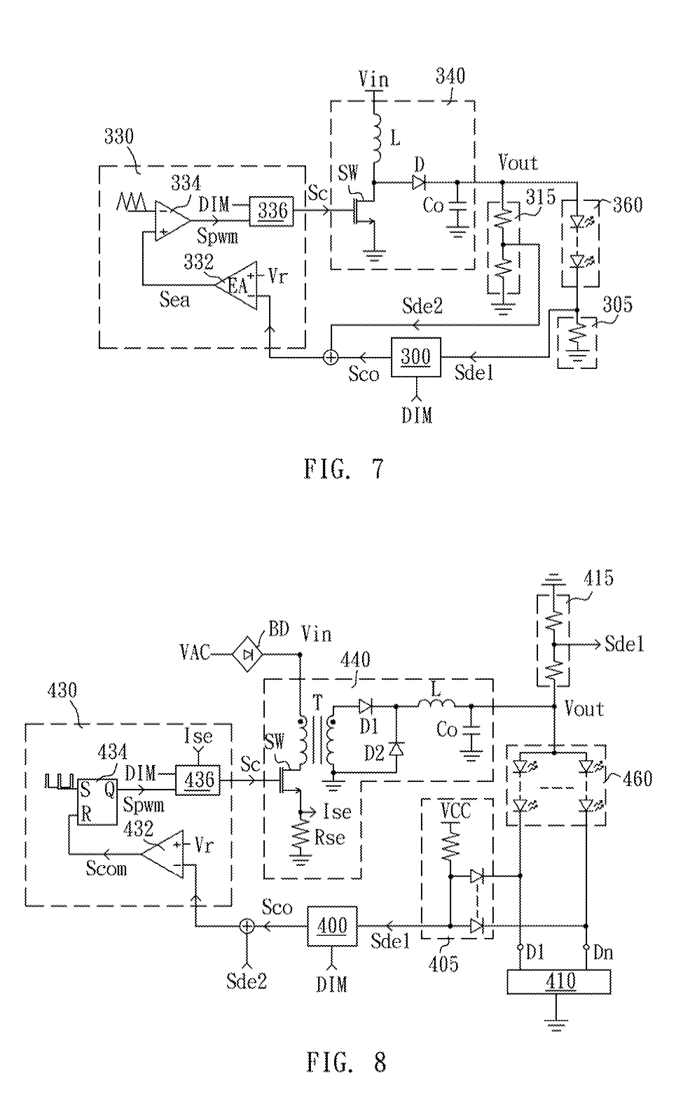

FIG. 7 is a schematic circuit diagram of a converting control circuit in accordance with a second preferred embodiment of the present invention. As shown in feedback circuit, the converting control circuit includes a feedback controller 330, detecting circuits 305,315, and a feedback circuit 300, and is utilized to control a converting circuit 340 to convert an input voltage into an adequate power to drive a load 360. The detecting circuit 305 is coupled to the load 360 for generating a detecting signal Sde1 according to a current flowing through the load 360. The detecting circuit 315 is coupled to the converting circuit 340 for generating a detecting signal Sde2 according to an output voltage Vout of the converting circuit 340. The feedback circuit 300 is coupled to the detecting circuit 305 and generates a feedback signal Sco according to the detecting signal Sde1 for modulating a level of the detecting signal Sde2. The feedback controller 330 receives the modulated detecting signal and outputs a control signal Sc to control the conversion operation of the converting circuit 340.

The feedback controller 330 includes an error amplifier 332, a pulse width modulation unit 334, and a driving circuit 336. The error amplifier 332 receives the modulated detecting signal at an inverting input end thereof and a reference voltage signal Vr at a non-inverting input end thereof, and outputs an amplified error signal Sea at an output end. The pulse width modulation unit 334 receives a ramp signal at an inverting input end thereof and the amplified error signal Sea at a non-inverting input end thereof so as to output a pulse width modulation signal Spwm. The driving circuit 336 is utilized to control the duty cycle of the control signal Sc according to the received pulse width modulation signal Spwm so as to have the load 360 being steadily driven by the converting circuit 340. The driving circuit 336 and the feedback circuit 300 may also receive a dimming signal DIM to dim the LED module in the load 360. In addition, the error amplifier 332 may be replaced by a trans-conductance unit, such as a trans-conductance amplifier.

In the present embodiment, the converting circuit 340 is a switch-mode DC-to-DC boost converting circuit, which includes an inductor L, a diode D, an output capacitor Co, and a switch SW. The switch SW is controlled by the control signal Sc so as to convert the input voltage Vin into the output voltage Vout. As a short circuit occurs in the load 360, the output voltage Vout will be applied to the feedback controller 330 through feedback loop directly according to the conventional converting control circuit. In contrast, because of the existence of the feedback circuit 300, the output voltage Vout will not be applied to the feedback controller 330 in accordance with the present embodiment, so as to prevent the feedback controller 330 from being burned by the high level output voltage Vout.

FIG. 8 is a schematic circuit diagram of a converting control circuit in accordance with a third preferred embodiment of the present invention. As shown in FIG. 8, the converting control circuit includes a current control circuit 410, detecting circuits 405- and 415, a feedback controller 430, and a feedback circuit 400, and is utilized to control a converting circuit 440 to convert an input voltage Vin into an output voltage Vout to drive a load 460. In the present embodiment, the load 460 has a plurality of LED strings connected in parallel. The current control circuit 410 has a plurality of control ends D1-Dn respectively connected with the LED strings for controlling the current on the LED strings respectively. The detecting circuit 405 includes a plurality of diodes, and has a positive end coupled to a common driving voltage end VCC through a resistor and a negative end coupled to corresponding control ends D1-Dn. The detecting circuit 405 generates the detecting signal Sde1 according to the level of the control end with a lowest voltage among all the control ends D1-Dn. The detecting circuit 415 is coupled to the converting circuit 440 and generates a detecting signal Sde2 according to the output voltage Vout of the converting circuit 440. The feedback circuit 400 is coupled to the detecting circuits 405 and 415, and generates a feedback signal Sco according to the detecting signal Sde1 to modulate the level of the detecting signal Sde2. The feedback controller 430 receives the modulated detecting signal to control the converting circuit 440 to convert the input voltage Vin into the output voltage Vout. The feedback controller 430 includes a comparing unit 432, a flip-flop unit 434, and a driving circuit 436. The comparing unit 432 receives the modulated detecting signal and a reference voltage signal Vr so as to generate a comparing signal Scorn. The flip-flop unit 434 receives the comparing signal and a periodic pulse signal so as to generate a pulse width modulation signal Spwm. In the present embodiment, the flip-flop unit 434 is a SR flip-flop, which receives the periodic pulse signal at the set end S and the comparing signal Scorn at the reset end R, and outputs the pulse width modulation signal Spwm at the output end Q. The driving circuit 436 receives the pulse width modulation signal Spwm, and controls the duty cycle of the control signal Sc accordingly so as to have the converting circuit 440 generate a steady power to drive the load 460. In the present embodiment, the converting circuit 440 is a forward converting circuit, which includes a transformer T, a switch SW, a current sensing resistor Rse, rectifying diodes D1 and D2, an inductor L, and an output capacitor Co. The current sensing resistor Rse generates a current sensing signal Ise for the driving circuit 436 according to the current flowing through the switch SW. The driving circuit 436 determines whether there is an over-current event or not. If so, the driving circuit 436 turns off the switch SW temporarily to prevent over-current damage.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A converting control circuit adapted for controlling a converting circuit to convert an input voltage into an output voltage to drive a load, the converting control circuit comprising:
a current control circuit having at least one control end coupled to the load for modulating a current of the load;
a first detecting circuit which is coupled to the current control circuit and generates a first detecting signal according to a voltage of the control end;
a second detecting circuit which is coupled to the converting circuit and generates a second detecting signal according to the output voltage;
a feedback controller controlling the converting circuit to convert the input voltage into the output voltage in response to the second detecting signal; and
a feedback circuit which is coupled to the first detecting circuit and the second detecting circuit, and generates a feedback signal to modulate a level of the second detecting signal according to the first detecting signal.

2. The converting control circuit of claim 1, wherein the feedback circuit comprising:
a capacitor for generating the feedback signal; and
a charging/discharging unit for charging or discharging the capacitor according to the first detecting signal.

3. The converting control circuit of claim 2, wherein the load is a LED module with a plurality of LED strings connected in series.

4. The converting control circuit of claim 3, wherein the current control circuit has a plurality of control ends respectively coupled to the LED strings, and the first detecting circuit is coupled to the control ends and generates the first detecting signal according to a level of the control end with a lowest level one among the control ends

5. The converting control circuit of claim 4, wherein the feedback circuit comprises a de-coupling unit for preventing power from being delivered from the second detecting circuit through the feedback circuit.

6. The converting control circuit of claim 4 wherein the feedback controller comprises:
an error amplifier for receiving the modulated second detecting signal to generate an error amplifying signal; and
a pulse width modulating unit for generating a pulse width modulating signal according to the error amplifying signal.

7. The converting control circuit of claim 4 wherein the feedback controller comprises:
a trans-conductance unit for receiving the modulated second detecting signal to generate a trans-conductance signal; and
a pulse width modulating unit for generating a pulse width modulating signal according to the trans-conductance signal.

8. The converting control circuit of claim 2, wherein the feedback circuit comprises a de-coupling unit for preventing power from being delivered from the second detecting circuit through the feedback circuit.

9. The converting control circuit of claim 2 wherein the feedback controller comprises:
an error amplifier for receiving the modulated second detecting signal to generate an error amplifying signal; and
a pulse width modulating unit for generating a pulse width modulating signal according to the error amplifying signal.

10. The converting control circuit of claim 2 wherein the feedback controller comprises:
a trans-conductance unit for receiving the modulated second detecting signal to generate a trans-conductance signal; and
a pulse width modulating unit for generating a pulse width modulating signal according to the trans-conductance signal.

11. The converting control circuit of claim 2 wherein the feedback controller comprises:
a comparing unit for receiving the modulated second detecting signal to generate a comparing signal; and
a flip-flop unit for generating a duty cycle modulating signal according to the comparing signal.

12. The converting control circuit of claim 1 wherein the feedback controller comprises:
an error amplifier for receiving the modulated second detecting signal to generate an error amplifying signal; and
a pulse width modulating unit for generating a pulse width modulating signal according to the error amplifying signal.

13. The converting control circuit of claim 1 wherein the feedback controller comprises:
a trans-conductance unit for receiving the modulated second detecting signal to generate a trans-conductance signal; and
a pulse width modulating unit for generating a pulse width modulating signal according to the trans-conductance signal.

14. The converting control circuit of claim 1, wherein the feedback controller comprises:
a impedance unit; and
a controlled current source for generating a current flowing through the impedance unit to generate the feedback signal according to the first detecting signal.

15. The converting control circuit of claim 14 wherein the feedback controller comprises:
a comparing unit for receiving the modulated second detecting signal to generate a comparing signal; and
a flip-flop unit for generating a duty cycle modulating signal according to the comparing signal.

16. A converting control circuit, adapted for controlling a converting circuit to convert an input voltage into an output voltage to drive a load, comprising:
a controller for controlling the converting circuit to convert the input voltage into the output voltage;
a detecting circuit coupled to the load for generating a detecting signal;
a feedback circuit coupled to the detecting circuit and generating a feedback signal according to the detecting signal, wherein the feedback circuit has:
a capacitor for generating the feedback signal; and
a charging/discharging unit for charging or discharging the capacitor.

17. The converting control circuit of claim 16 further comprising a current control circuit, wherein the load is a LED module with a plurality of LED strings connected in series, and the current control circuit has a plurality of control ends respectively connected to the LED strings, and the detecting circuit is coupled to the control ends for generating the detecting signal according to a level of the control end with a lowest voltage among the control ends.

18. The converting control circuit of claim 16, wherein the converting circuit is a switching type converting circuit.

19. A converting control circuit, adapted for converting an input voltage into an output current to drive a load, comprising:
a detecting circuit coupled to the load for generating a detecting signal; and
a feedback circuit coupled to the detecting circuit and generating a feedback signal according to the detecting signal, wherein the feedback circuit comprises:
a capacitor for generating the feedback signal; and
a charging/discharging unit for charging or discharging the capacitor; and
a regulator coupled between the input voltage and the load for supplying the output current at a predetermined current value in response to the feedback signal.

20. The converting control circuit of claim 19, wherein the regulator is a low dropout regulator.
